(19) United States
(12) Patent Application Publication
(10) Pub. No.: US 2017/0351976 A1
(43) Pub. Date: Dec. 7, 2017

(54) AUTOMATIC SEAT ASSIGNING METHOD AND AUTOMATIC SEAT ASSIGNING SYSTEM

(71) Applicant: Acer Incorporated, New Taipei City (TW)

(72) Inventor: Sen-Yi Lin, New Taipei City (TW)

(73) Assignee: Acer Incorporated, New Taipei City (TW)

(21) Appl. No.: 15/377,685

(22) Filed: Dec. 13, 2016

(30) Foreign Application Priority Data
Jun. 4, 2016 (TW) 105117705

(51) Int. Cl. G06Q 10/02

(52) U.S. Cl. CPC G06Q 10/02

(57) ABSTRACT

The present invention provides an automatic seat assigning method and automatic seat assigning system. The automatic seat assigning method includes: constructing coordinate information of a plurality of seats and a viewing target; calculating a viewing distance between each of the seats and the viewing target according to the coordinate information; calculating a viewing angle offset of each of the seats according to the coordinate information; determining priority of the seats according to the viewing distances and the viewing angle offsets; and assigning the seats according to the priority.

### CROSS-REFERENCE TO RELATED APPLICATION

This application claims the priority benefit of Taiwan application serial no. 105117705, filed on Jun. 4, 2016. The entirety of the above-mentioned patent application is hereby incorporated by reference herein and made a part of this specification.

### BACKGROUND OF THE INVENTION

### Field of the Invention

The invention relates to an automatic seat assigning method and an automatic seat assigning system, and particularly relates to an automatic seat assigning method capable of selecting better seats in priority and an automatic seat assigning system.

### Description of Related Art

Along with development of Internet, Internet ticket booking services are developed. For example, people may purchase tickets of a concert, a stage play, a musical performance, or a sports event through the Internet. Now, regarding a place with limited seats, people may select manual seat assignment or select computer system automatic seat assignment when book the tickets through the Internet. However, the seat selected according to a computer seat assigning logic is generally not a seat that has the best viewing experience. In order to select a better seat, a complicated program computation has to be taken.

Taking FIG. 1 as an example, in a present computer seat assigning system, the seats are generally assigned in a sequence from the left to the right or from the right to the left, and in a sequence from top to bottom along a direction facing a viewing target 101. If the seat to be assigned is already sold, the system seeks a next adjacent seat that is not sold. When the user wants to buy multiple tickets, the system may seek continuous available seats with a quantity greater than a purchase number of the tickets, and the continuous available seats cannot be in different rows, cross ticket zones, or cross an aisle.

In the present computer seat assigning system, in response to a relative position relationship between each of the ticket zones and the viewing target, a sorting rule of priority of the seats of each of the ticket zones is not consistent. For example, a sorting mile of a ticket zone A is from right to left and from top to bottom, a sorting rule of a ticket zone B is from left to right, a sorting rule of a ticket zone D is first from top to bottom and then from right to left. Since a ticket zone C right faces a stage, regardless of from left to right or from right to left, it is not the most appropriate method, so that the ticket zone C is not adapted to the aforementioned sorting rules and requires exception handling. Moreover, the seat assigned according to the aforementioned seat assigning logic is probably not the best seat in the ticket zone, for example, a seat 111 located at “No. 3 of 5^{th} row of zone A” has a better field of view compared to that of a seat 112 located at “No. 16 of 2^{nd} row of zone A”, though the seat of “No. 16 of 2^{nd} row of zone A” is assigned in priority according to such seat assigning logic, which is the most common problem that causes consumer's complaints in computer automatic seat assignment.

Moreover, if a shape of the ticket zone is irregular, the ticket zone is also not adapted to the aforementioned sorting rule and requires exception handling. Namely, the logic of the aforementioned computer automatic seat assignment is not adapted to all of the ticket zones, and the rules are completed, and computer program implementation is time-consuming, and has a high cost and poor performance. Therefore, how to design an efficient computer automatic seat assigning system capable of determining better seats is a goal of effort of related technicians of the field.

### SUMMARY OF THE INVENTION

The invention is directed to an automatic seat assigning method, which is adapted to automatically select seats with better field of view from remained seats through a simple calculation process.

An exemplary embodiment of the invention provides an automatic seat assigning method, which includes following steps. Coordinate information of a plurality of seats and a viewing target is constructed based on a coordinate system. A viewing distance between each of the seats and the viewing target is calculated according to the coordinate information. A viewing angle offset of each of the seats is calculated according to the coordinate information. A priority of the seats is determined according to the viewing distances and the viewing angle offsets. The seats are assigned according to the priority.

According to another aspect, an exemplary embodiment of the invention provides an automatic seat assigning system including a rendering module, a storage module and a seat assigning module. The rendering module constructs coordinate information of a plurality of seats and a viewing target based on a coordinate system, calculates a viewing distance between each of the seats and the viewing target according to the coordinate information, calculates a viewing angle offset of each of the seats according to the coordinate information, and determines a priority of the seats according to the viewing distances and the viewing angle offsets. The storage module is coupled to the rendering module, and stores the coordinate information, the viewing distance, the viewing angle offset and the priority of each of the seats. The seat assigning module assigns the seats according to the priority.

According to the above descriptions, the invention provides an automatic seat assigning method and an automatic seat assigning system, and coordinate information of the seats and the viewing target is constructed, and the priority of each of the seats is determined according to the viewing distances and the viewing angle offsets, such that the seats with better field of view are selected in priority from the remained seats when the user selects computer seat assignment.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional automatic seat assigning method.

FIG. 2 is a block diagram of an automatic seat assigning system according to an exemplary embodiment of the invention.

FIG. 3 is a schematic diagram of an automatic seat assigning method according to an exemplary embodiment of the invention.

FIG. 4 is a flowchart illustrating a site drawing method according to an exemplary embodiment of the invention.

FIG. 5 is a flowchart illustrating an automatic seat assigning method according to an exemplary embodiment of the invention.

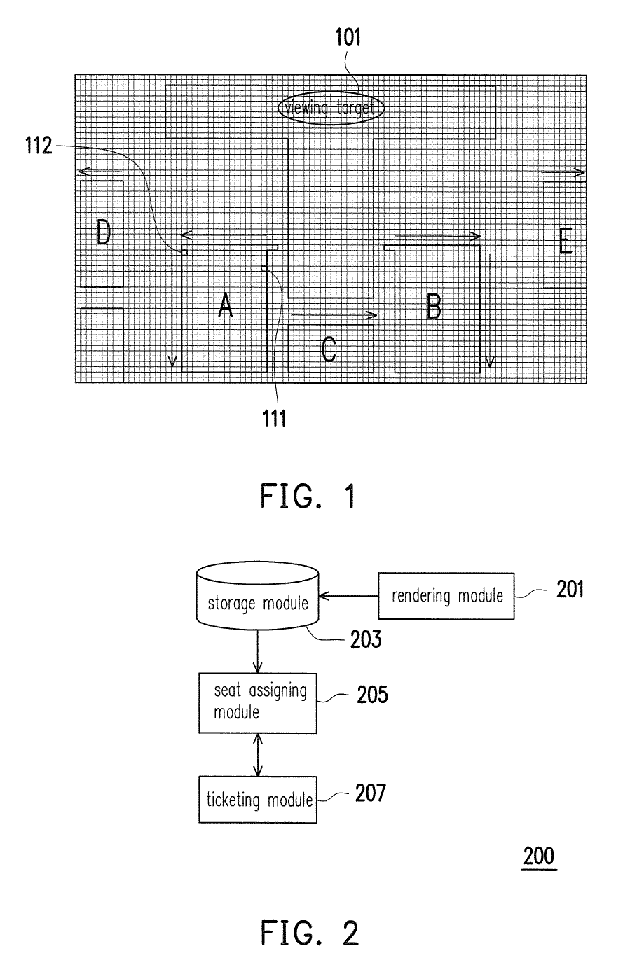

### DESCRIPTION OF EMBODIMENTS

FIG. 2 is a block diagram of an automatic seat assigning system according to an exemplary embodiment of the invention.

Referring to FIG. 2, the automatic seat assigning system 200 of the present embodiment includes a rendering module 201, a storage module 203, a seat assigning module 205 and a ticketing module 207. The automatic seat assigning system 200 can be implemented by at least one electronic device having computation capability. The electronic device can be a desktop computer, a notebook computer, a server, a workstation computer, etc., that has the computation capability, which may include (but not limited to) a processor (not shown) (for example, a central processing unit (CPU), a microprocessor, a digital signal processor (DSP), a programmable controller, an application specific integrated circuit (ASIC)).

The rendering module 201 can be software and is executed by at least one processor of a personal computer or a server. The storage module 203 is, for example, a hard disk, a solid state disk or a similar device or a combination of the above devices of the personal computer or the server. The seat assigning module 205 can be software and is executed by at least one processor of the personal computer or the server. The ticketing module 207 can be software and is executed by at least one processor of the personal computer or the server. The ticketing module 207 provides a ticket booking interface to the user, and receives ticket information of the user through a network. The ticket information may include a viewing time, a ticket zone selected by the user, and a purchase amount decided by the user. In this way, the user may use a portable electronic device or a ticketing device of a supermarket to transfer the ticket information to the ticketing module 207 through the network.

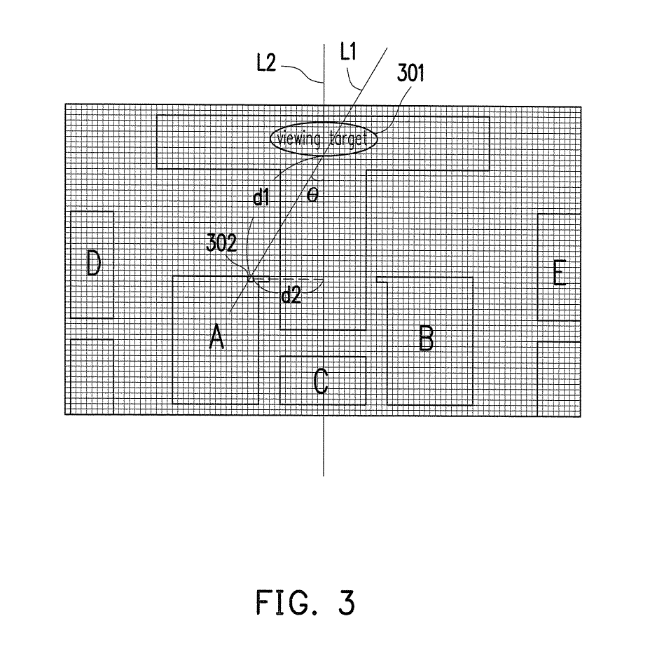

Referring to FIG. 2 and FIG. 3, the rendering module 201 may provide a system manager to render a site plan, and automatically constructs coordinate information of a plurality of seats and a viewing target 301 based on a coordinate system. The coordinate system can be a two-dimensional coordinate system or a three-dimensional coordinate system, which is not limited by the invention. For example, when the coordinate system is a plane coordinate system, after a vertical axial direction, a horizontal axial direction, a unit distance and an origin position are defined, the rendering module 201 may accordingly generate coordinates corresponding to each of the seats and coordinates of the viewing target 301. Namely, the coordinate information may include the coordinates of the seats and the coordinates of the viewing target 301.

After constructing the coordinate information, the rendering module 201 calculates a viewing distance (or referred to as a Euclidean distance) between each of the seats and the viewing target 301 according to the coordinate information. For simplicity's sake, it is assumed that the origin of the coordinate system is a most top left corner of the site plan, though the invention is not limited thereto. It is assumed that a coordinate of the most top left corner is (0, 0), a coordinate of the viewing target 301 is (x1, y1), a coordinate of a seat 302 is (x2, y2), a viewing distance between the seat 302 and the viewing target 301 is then d1=Sqrt((x1-x2)²+(y1-y2)²). Then, the rendering module 201 calculates a viewing angle offset of each of the seats according to the coordinate information.

In an exemplary embodiment, the rendering module 201 calculates an included angle θ=tan⁻¹((|x1-x2|)/(|y1-y2|)) between a line L1 passing through the seat 302 and the viewing target 301 and a reference line L2, and takes the included angle θ as the viewing angle offset. The reference line L2 passes through the viewing target 301 and is parallel to a first direction, where the first direction is the vertical axial direction of the coordinate system. In the exemplary embodiment of FIG. 3, a linear equation of the reference line L2 is x=y1. Then, the rendering module 201 determines a priority of the seat 302 according to the calculated viewing distance dl and the included angle θ. Namely, the rendering module 201 may sort each of the seats according to the viewing distance and the viewing angle offset corresponding to the seat to obtain the priority of the seats. In the present exemplary embodiment, the seats located closer to the viewing target 301 have higher priority, and if the viewing distances between two seats and the viewing target 301 are the same, the seat with a smaller included angle θ has higher priority. The aforementioned same viewing distance refers to that a difference between the viewing distances respectively between the two seats and the viewing target 301 is smaller than a threshold. Alternatively, the aforementioned same viewing distance may refer to that two viewing distances are equivalent after rounding. On the other hand, in another exemplary embodiment, in a cinema automatic seat assigning system, since the rear seats of the cinema may have a better visual effect, when the priority of the seats is set, the seats located away from the viewing target 301 can be set to have higher priority.

In the aforementioned exemplary embodiment, the included angle θ is taken as the viewing angle offset, though the invention is not limited thereto. In another exemplary embodiment, the rendering module 201 may take a distance d2=|x1-x2| between the seat 302 and the reference line L2 as the viewing angle offset, and determines the priority according to the distance d1 first, and if the viewing distances dl of two seats are the same, the rendering module 201 determines the priority according to the distance d2.

The storage module 203 is coupled to the rendering module 201, and stores the coordinate information, a seat number, the viewing distance, the viewing angle offset and the priority of each of the seats. When the user operates the ticketing module 207 to buy tickets, the ticketing module 207 obtains the priority from the seat assigning module 206 to assign the seats according to the priority.

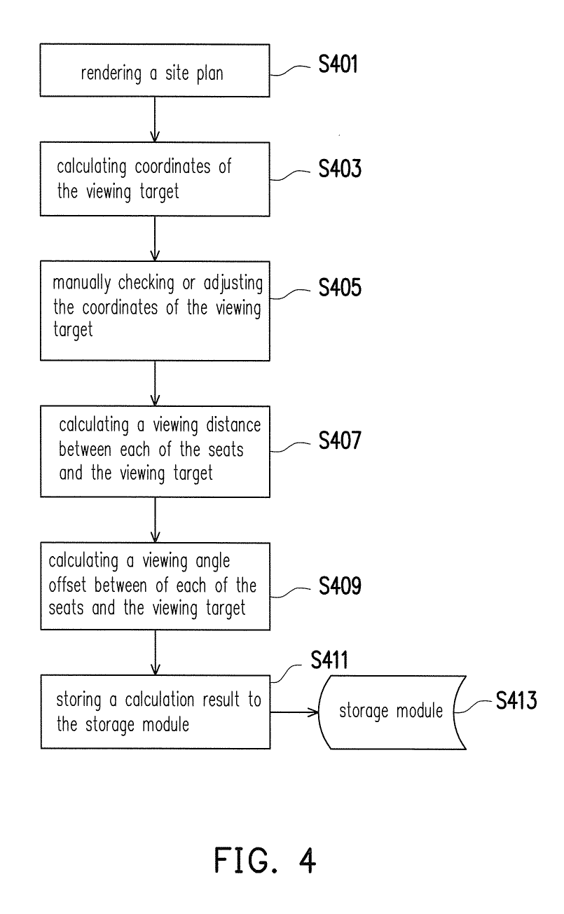

FIG. 4 is a flowchart illustrating a site drawing method according to an exemplary embodiment of the invention.

Referring to FIG. 4, when a ticket selling site is determined, in step S401, the system manager may render a site plan through the rendering module 201. In step S403, coordinates of all of the seats and the viewing target are calculated through the rendering module 201, for example, a stage or a center point of a movie screen is calculated to serve as the coordinates of the viewing target. In step S405, the system manager may manually check or adjust the coordinates of the viewing target. In step S407, the rendering module 201 may calculate a viewing distance between each of the seats and the viewing target. In step S409, the rendering module 201 may calculate a viewing angle offset between of each of the seats and the viewing target, and determine priory of the seats according to the viewing distances and the viewing angle offsets. It should be noted that the rendering module 201 may take the included angel between a line passing through each of the seats and the viewing target and a reference line parallel to a seat facing direction as the viewing angle offset, and may take a vertical distance between each of the seats and the aforementioned reference line as the viewing angle offset. In step S411, the rendering module 201 stores a calculation result to the storage module 203. In step S413, the storage module 203 stores priority data of each of the seats.

In an exemplary embodiment, the rendering module 201 may first calculate the viewing distance between each of the seats and the viewing target. Taking the seat 302 of FIG. 3 as an example, the viewing distance d1 is, for example, “112.115” after unconditional rounding. Then, the rendering module 201 calculates the viewing angel offset of each of the seats. Taking the seat 302 of FIG. 3 as an example, the viewing angle offset θ is, for example, 30.5 after unconditional rounding. Then, the rendering module 201 generates a priority weight “122115305” by combining the viewing distance dl and the viewing angle offset θ of the rendering module 201. In this way, by sorting the priority weights of the seats, the priority of each of the seats is determined. The aforementioned description is only an exemplary embodiment, and the invention is not limited thereto.

It should be noted that if a seat demand ordered by the user is greater than one, in the invention, the seats in serial numbers and with better viewing experience can be selected according to the seat demand. The user may input a quantity of ordered tickets (i.e. the aforementioned seat demand) through the ticketing module 207. To be specific, when the seat assigning module 205 determines that the seat demand is greater than one, the seat assigning module 205 selects one matching seat from the seats according to the priority, and obtains a quantity of available seats in serial numbers located adjacent to the matching seat. The available seats can be seats that are still not purchased by the users. Thereafter, the seat assigning module 205 determines whether the quantity of the available seats in serial numbers is equal to the seat demand of the user. When the quantity of the available seats in serial numbers is not equal to the seat demand, the seat assigning module 205 selects another matching seat from the seats according to the priority.

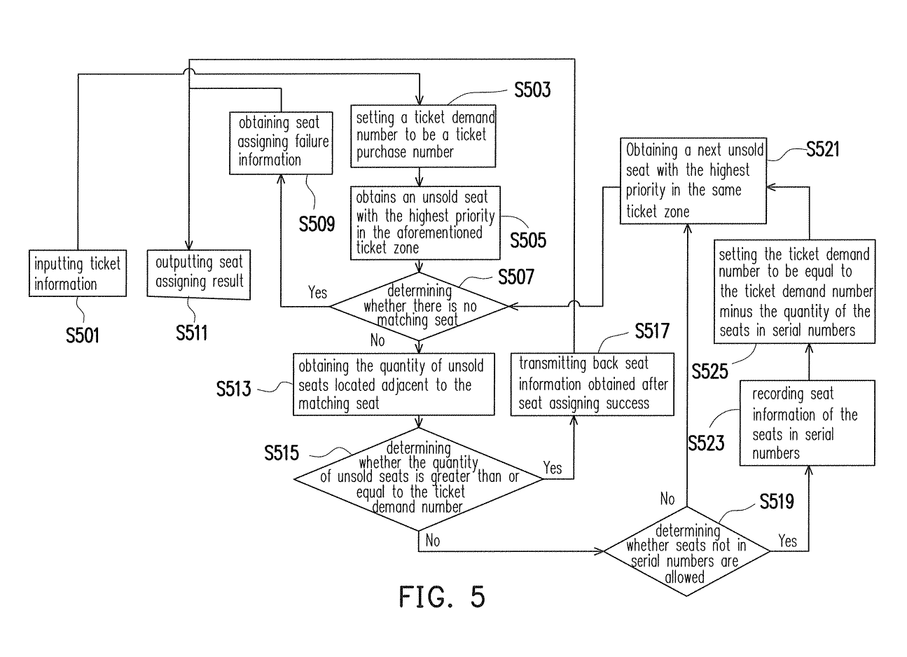

An embodiment is provided below to describe the seat assigning method of the seat assigning module 205. FIG. 5 is a flowchart illustrating an automatic seat assigning method according to an exemplary embodiment of the invention. Referring to FIG. 5, in step S501, the user inputs ticket information through the ticketing module 207, where the ticket information includes a purchased program, a viewing time, a ticket zone, a ticket number, whether non-continuous seats are allowed, etc. The seat assigning module 205 receives the ticket information, and sets a ticket demand number to be a ticket purchase number in step S503, and obtains an unsold seat with the highest priority in the aforementioned ticket zone in step S505. The method for obtaining the seats with the highest priority has been described with reference of FIG. 2 and FIG. 3, so that detail thereof is not repeated. In step S507, the seat assigning module 205 determines whether there is no matching seat, and if yes, in step S509, the seat assigning module 205 obtains seat assigning failure information, and outputs the seat assigning failure information to the ticketing module 207 to notify the user in step S511.

In the step S507, if the seat assigning module 205 determines that there is a matching seat, in step S513, the quantity of unsold seats located adjacent to the matching seat is obtained, and in step S515 it is determined whether the quantity of unsold seats is greater than or equal to the ticket demand number. If the quantity of unsold seats is greater than or equal to the ticket demand number, in step S517, seat information obtained after seat assigning success is transmitted back, and in the step S511, the seat information of seat assigning success is output to the ticketing module 207 to notify the user. If the quantity of unsold seats is smaller than the ticket demand number, in step S519, it is determined whether seats not in serial numbers are allowed according to the input ticket information. If the seats not in serial numbers are not allowed, in step S521, a next unsold seat with the highest priority is obtained in the same ticket zone, and the method flow returns to the step S507 to continually determine whether there is no matching seat. If the seats not in serial numbers are allowed, in step S523, seat information of the seats in serial numbers is recorded, and in step S525, the ticket demand number is set to be equal to the ticket demand number minus the quantity of the seats in serial numbers, and then the method flow returns to the step S521 to obtain a next unsold seat with the highest priority in the same ticket zone. Namely, the seat assigning module 205 first assigns the seats in serial numbers and with the highest priority to the user, and then selects the seats making up for the ticket purchase number from the seats in serial numbers of a next priority.

In summary, the automatic seat assigning method and the automatic seat assigning system of the invention may construct the coordinate information of the seats and the viewing target, and determine priority of the seats according to the viewing distances and the viewing angle offsets, so as to select the seats with better field of view in priority from the remained seats in seat assignment. When the user wants to purchase multiple tickets, the continuous unsold seats with the highest priority are first provided to the user, and then the rest seats are complemented by the continuous unsold seats of a next priority. Therefore, according to the automatic seat assigning method and the automatic seat assigning system of the invention, the computer seat assigning rules are more simple, so as to save development cost of the computer automatic seat assigning system and improve computer automatic seat assigning efficiency. The best seats assigned according to the priority of the invention are more accurate compare to the conventional system, such that customer satisfaction is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An automatic seat assigning method, comprising:
constructing coordinate information of a plurality of seats and a viewing target based on a coordinate system;
calculating a viewing distance between each of the seats and the viewing target according to the coordinate information;
calculating a viewing angle offset of each of the seats according to the coordinate information;
determining a priority of the seats according to the viewing distances and the viewing angle offsets; and
assigning the seats according to the priority.

2. The automatic seat assigning method as claimed in claim 1, wherein the viewing angle offset is an included angle between a line passing through each of the seats and the viewing target and a reference line, wherein the reference line passes through the viewing target and is parallel to a first direction, and the first direction is a vertical axial direction of the coordinate information.

3. The automatic seat assigning method as claimed in claim 1, wherein the viewing angle offset is a vertical distance between each of the seats and a reference line, wherein the reference line passes through the viewing target and is parallel to a first direction, and the first direction is a vertical axial direction of the coordinate system.

4. The automatic seat assigning method as claimed in claim 1, wherein the step of determining the priority of the seats according to the viewing distances and the viewing angle offsets comprises:
comparing the viewing distances of a first seat and a second seat among the seats to determine the priority; and
comparing viewing the angle offsets of the first seat and the second seat to determine the priority when the viewing distances of the first seat and the second seat are the same.

5. The automatic seat assigning method as claimed in claim 1, wherein the step of assigning the seats according to the priority comprises:
selecting a matching seat from the seats according to the priority when a seat demand is determined to be greater than one, and obtaining a quantity of available seats in serial numbers located adjacent to the matching seat;
determining whether the quantity of the available seats in serial numbers is equal to the seat demand; and
selecting another matching seat from the seats according to the priority when the quantity of the available seats in serial numbers is not equal to the seat demand.

6. An automatic seat assigning system, comprising:
a rendering module, constructing coordinate information of a plurality of seats and a viewing target based on a coordinate system, calculating a viewing distance between each of the seats and the viewing target according to the coordinate information, calculating a viewing angle offset of each of the seats according to the coordinate information, and determining a priority of the seats according to the viewing distances and the viewing angle offsets;
a storage module, coupled to the rendering module, and configured to store the coordinate information, the viewing distance, the viewing angle offset and the priority of each of the seats; and
a seat assigning module, coupled to the rendering module, and assigning the seats according to the priority.

7. The automatic seat assigning system as claimed in claim 6, wherein the viewing angle offset is an included angle between a line passing through each of the seats and the viewing target and a reference line, wherein the reference line passes through the viewing target and is parallel to a first direction, and the first direction is a vertical axial direction of the coordinate information.

8. The automatic seat assigning system as claimed in claim 6, wherein the viewing angle offset is a vertical distance between each of the seats and a reference line, wherein the reference line passes through the viewing target and is parallel to a first direction, and the first direction is a vertical axial direction of the coordinate system.

9. The automatic seat assigning system as claimed in claim 6, wherein the rendering module compares the viewing distances of a first seat and a second seat among the seats to determine the priority, wherein when the viewing distances of the first seat and the second seat are the same, the rendering module compares the viewing angle offsets of the first seat and the second seat to determine the priority.

10. The automatic seat assigning system as claimed in claim 6, wherein when the seat assigning module determines a seat demand to be greater than one, the seat assigning module selects a matching seat from the seats according to the priority, and obtains a quantity of available seats in serial numbers located adjacent to the matching seat, and the seat assigning module determines whether the quantity of available seats in serial numbers is equal to the seat demand, wherein when quantity of available seats in serial numbers is not equal to the seat demand, the seat assigning module selects another matching seat from the seats according to the priority.
